(19) United States
(12) Patent Application Publication
(10) Pub. No.: US 2005/0125557 A1
(43) Pub. Date: Jun. 9, 2005

(54) Transaction transfer during a failover of a cluster controller

(75) Inventors: Bharath Vasudevan, Austin, TX (US); Nam Nguyen, Round Rock, TX (US)

Correspondence Address: BAKER BOTTS, LLP, 910 LOUISIANA, HOUSTON, TX, 77002-4995, US

(73) Assignee: Dell Products L.P.

(21) Appl. No.: 10/730,349

(22) Filed: Dec. 8, 2003

(51) Int. Cl. G06F 15/173

(52) U.S. Cl. 709/239

(57) ABSTRACT

An apparatus, system, and method are provided for causing a failed node in a cluster to transfer its outstanding transaction queue to one or more surviving nodes. The heartbeat of the various cluster nodes is used to monitor the nodes within the cluster as the heartbeat is a dedicated link between the cluster nodes. If a failure is detected anywhere within the cluster node (such as a network section, hardware failure, storage device, or interconnections) then a failover procedure will be initiated. The failover procedure includes transferring the transaction queue from the failed node to one or more other nodes within the cluster so that the transactions can be serviced, preferably before a time out period, so that clients are not prompted to re-request the transaction.

### TECHNICAL FIELD OF THE DISCLOSURE

The present disclosure relates, in general, to the field of information handling systems and, more particularly, to computer clusters having a failover mechanism.

### BACKGROUND OF THE RELATED ART

As the value and the use of information continue to increase, individuals and businesses seek additional ways to process and store information. One option available to users is information handling systems. An information handling system generally processes, compiles, stores and/or communicates information or data for business, personal or other purposes, thereby allowing users to take advantage of the value of the information. Because technology and information handling needs and requirements vary between different users or applications, information handling systems may also vary regarding what information is handled, how the information is handled, how much information is processed, stored, or communicated, as well as how quickly and efficiently the information may be processed, stored, or communicated. The variations in information handling systems allow for information handling systems to be general, or to be configured for a specific user or a specific use, such as financial transaction processing, airline reservations, enterprise data storage, or global communications. In addition, information handling systems may include a variety of hardware and software components that may be configured to process, store, and communicate information, and may include one or more computer systems, data storage systems, and networking systems, e.g., computer, personal computer workstation, portable computer, computer server, print server, network router, network hub, network switch, storage area network disk array, redundant array of independent disks (“RAID”) system and telecommunications switch.

Computers, such as servers or workstations, are often grouped in clusters in order to perform specific tasks. A server cluster is a group of independent servers that is managed as a single system for higher availability, manageability, and scalability. As a minimum, a server cluster is composed of two or more servers that are connected by a network. In addition, the cluster must have a method for each server to access the other server's disk data. Finally, some software application is needed to manage the cluster. One such management tool is the Microsoft Cluster Storage® (“MSCS”) which is produced by the Microsoft Corporation of Redmond, Wash. Clustering typically involves the configuring of a group of independent servers so that the servers appear on a network as a single machine. Often, clusters are managed as a single system, share a common namespace, and are designed specifically to tolerate component failures and to support the addition or subtraction of components in a transparent manner.

With the advent of eight-node clusters, cluster configurations with several active nodes (up to eight active nodes) are possible. An active node in a high-available (“HA”) cluster hosts some application, and a passive node waits for an active node to fail so that the passive node can host the failed node's application. Cluster applications have their data on a shared storage area network (“SAN”) attached disks that are accessible by all of the nodes. At any point in time, only the node that hosts an application can own the application's shared disks. In this scenario, where the applications remain spread across different nodes of the cluster, there arises a requirement to have a cluster backup solution that is completely SAN based, using a shared tape library that is accessible by all of the nodes of the cluster. Moreover, there is also a need for the solution to the problem to be failover aware because the applications may reside on different (failover or backup nodes) at different points in time during the backup cycle.

When a cluster is recovering from a server failure, the surviving server accesses the failed server's disk data via one of three techniques that computer clusters use to make disk data available to more than one server: shared disks, mirrored disks, and simply not sharing information.

The earliest server clusters permitted every server to access every disk. This originally required expensive cabling and switches, plus specialized software and applications. (The specialized software that mediates access to shared disks is generally called a Distributed Lock Manager (“DLM”). Today, standards like SCSI have eliminated the requirement for expensive cabling and switches. However, shared-disk clustering still requires specially modified applications. This means it is not broadly useful for the variety of applications deployed on the millions of servers sold each year. Shared-disk clustering also has inherent limits on scalability since DLM contention grows exponentially as servers are added to the cluster. Examples of shared-disk clustering solutions include Digital VAX Clusters available from Hewlett-Packard Company, of Palo Alto, Calif., and Oracle Parallel Server available from Orade Corporation of Redwood Shores, Calif.

A flexible alternative to shared disks is to let each server have its own disks, and to run software that “mirrors” every write from one server to a copy of the data on at least one other server. This useful technique keeps data at a disaster recovery site in sync with a primary server. A large number of disk-mirroring solutions is available today. Many of the mirroring vendors also offer cluster-like HA extensions that can switch workload over to a different server using a mirrored copy of data. However, mirrored-disk failover solutions cannot deliver the scalability benefits of clusters. It is also arguable that mirrored-disk failover solutions can never deliver as high a level of availability and manageability as the shared-disk clustering solutions since there is always a finite amount of time during the mirroring operation in which the data at both servers is not one hundred percent (100%) identical.

In response to the limitations of shared-disk clustering, modem cluster solutions employ a “shared nothing” architecture in which each server owns its own disk resources (that is, the servers share “nothing” at any point in time). In case of a server failure, a shared-nothing cluster has software that can transfer ownership of a disk from one server to another. This provides the same high level of availability as shared-disk clusters, and potentially higher scalability since it does not have the inherent bottleneck of a DLM. Best of all, a shared nothing cluster works with standard applications since there's no special disk access requirements.

MSCS clusters provide high-availability to customers by providing a server failover capability. If a server goes down due to either a hardware or to a software failure, the remaining nodes within the cluster will assume the load that was being handled by the failed server and will resume operation to the failed server's clients. In order to increase uptime, other techniques to improve fault tolerance within a server, such as hot plug components, redundant adapters and multiple network interfaces, are also implemented on customer environments.

When a cluster node receives a request, the node processes that request and returns a result. Within the current MSCS implementation, after the failure of a node, resources will fail over to the remaining nodes only after a series of retries has failed. While the retries are failing, any requests that are resident (queued) in the now-failed cluster node will either timeout or return to the client with an error message. These timeouts or bad returns happened because of the failure of the node. If the client issued the request from a cluster-aware application, the client will have to retry the request after the timeout. However, if the client did not issue the request from a cluster-aware application, the client request will fail, and the client will need to rescend (need to be retried) the request (manually). In either case, however, the timeout or failure is needless because another node in the cluster should have serviced the failed node. There is, therefore, a need in the art for a failover system that will not allow workable requests to be neglected until the timeout period, and there is a further need to relieve the client from retrying a request in case of a node failure.

### SUMMARY OF THE INVENTION

In accordance with the present disclosure, a system and method are provided for transferring the transaction queue of a first server within a cluster to one or more other servers within the same cluster when the first server is unable to perform the transactions. All servers within the cluster are provided with a heartbeat mechanism that is monitored by one or more other servers within the cluster. If a process on a server becomes unstable, or if a problem with the infrastructure of the cluster prevents that server from servicing a transaction request, then all or part of the transaction queue from the first server can be transferred to one or more other servers within the cluster so that the client requests (transactions) can be serviced.

According to one aspect of the present disclosure, a method for managing a cluster is provided that enables the servicing of requests even when a node and/or section of the cluster is inoperative. According to another aspect of the present disclosure, a method for employing a heartbeat mechanism between nodes of the cluster enables the detection of problems so that failover operations can be conducted in the event of a failure. According to another aspect of the present disclosure, during a failover operation, a transaction queue from one server can be moved to another server, or to another set of servers. Similarly, a copy of the transaction queues for each of the servers within the cluster can be stored in a shared source so that, if one server fails completely and is unable to transfer its transaction queue to another server, the copy of the transaction queue that is stored in the shared data source can be transferred to one or more servers so that the failed server's transactions can be completed by another server.

In one embodiment, the system may also include a plurality of computing platforms communicatively coupled to the first node. These computing platforms may be, for example, a collection of networked personal computers and/or a set of server computers. The system may also include a Fibre Channel (“FC”) switch communicatively coupled to the first node and to a plurality of storage resources. The FC switch may, in some embodiments, include a central processing unit operable to execute a resource management engine. A system and method incorporating teachings of the present disclosure may provide significant improvements over conventional cluster resource backup/failover solutions. In addition, the teachings of the present disclosure may facilitate other ways to reallocate workload among servers and/or nodes within a cluster in case of a failure of any node or portion of the cluster infrastructure. Other technical advantages should be apparent to one of ordinary skill in the art in view of the specification, claims, and drawings.

### BRIEF DESCRIPTION OF THE DRAWINGS

A more complete understanding of the present disclosure and advantages thereof may be acquired by referring to the following description taken in conjunction with the accompanying drawings, in which like reference numbers indicate like features, and wherein:

FIG. 1 is a block diagram illustrating an information handling system capable of implementing all or part of the present disclosure;

FIG. 2 is a block diagram illustrating a two-node failover cluster;

FIG. 3 is a block diagram illustrating a two-node failover cluster with a failed storage path; and

FIG. 4 is a block diagram illustrating a two-node failover cluster implementing an embodiment of the present disclosure.

The present disclosure may be susceptible to various modifications and alternative forms. Specific exemplary embodiments thereof are shown by way of example in the drawing and are described herein in detail. It should be understood, however, that the description set forth herein of specific embodiments is not intended to limit the present disclosure to the particular forms disclosed. Rather, all modifications, alternatives, and equivalents falling within the spirit and scope of the invention as defined by the appended claims are intended to be covered.

### DETAILED DESCRIPTION OF THE PREFERRED EMBODIMENTS

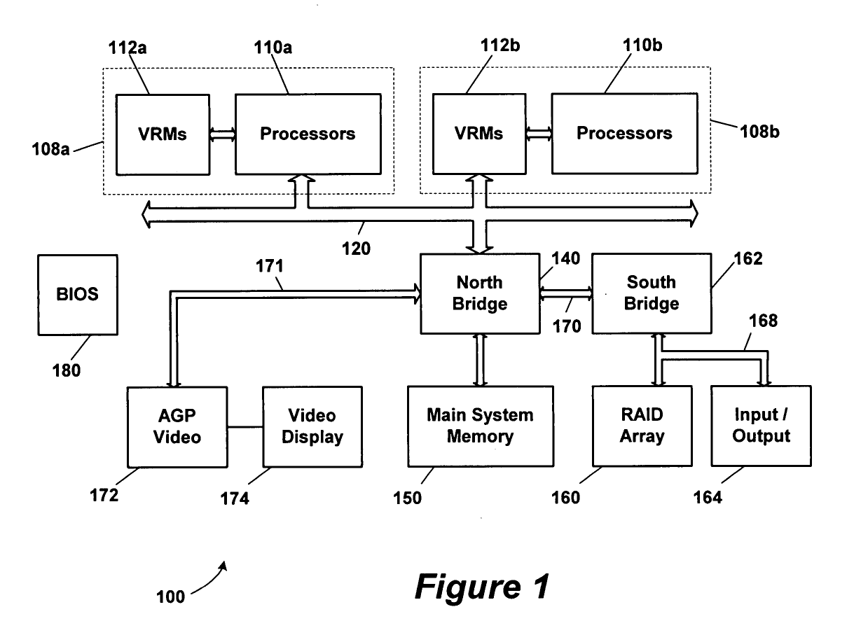

The present disclosure provides a cluster with a set of nodes, each node being capable of transferring its outstanding transaction queue to the surviving nodes using the cluster heartbeat. The cluster heartbeat is a dedicated link between the cluster nodes which tells every other node that the node is active and operating properly. If a failure of a node is detected within a cluster node (e.g., network, hardware, storage, interconnects, etc.), then a failover will be initiated. The present disclosure relates to all conditions where the cluster heartbeat is still intact and the failing node is still able to communicate to other node(s) in the cluster. Examples of such a failure are failure of a path to the storage system, and failure of an application. With the present disclosure, the surviving nodes can serve outstanding client- requests after assuming the load from the failed node without waiting until after the requests timeout. Thus, present disclosure helps make non-cluster-aware clients survive a cluster node failure. Instead of becoming disconnected because of a failed request, the client can switch the connection to the new node. Elements of the present disclosure can be implemented on a computer system as illustrated in FIG. 1.

Referring to FIG. 1, depicted is an information handling system having electronic components mounted on at least one printed circuit board (“PCB”) (not shown) and communicating data and control signals therebetween over signal buses. In one embodiment, the information handling system is a computer system. The information handling system, generally referenced by the numeral 100, comprises processors 110 and associated voltage regulator modules (“VRMs”) 112 configured as processor nodes 108. There may be one or more processors 110, VRMs 112 and processor nodes 108, illustrated in FIG. 1 by nodes 110a and 110b, 112a and 112b and 108a and 108b, respectively. A north bridge 140, which may also be referred to as a “memory controller hub” or a “memory controller,” is coupled to a main system memory 150. The north bridge 140 is coupled to the processors 110 via the host bus 120. The north bridge 140 is generally considered an application specific chip set that provides connectivity to various buses, and integrates other system functions such as memory interface. For example, an INTEL® 820E and/or INTEL® 815E chip set, available from the Intel Corporation of Santa Clara, Calif., provides at least a portion of the north bridge 140. The chip set may also be packaged as an application specific integrated circuit (“ASIC”). The north bridge 140 typically includes functionality to couple the main system memory 150 to other devices within the information handling system 100. Thus, memory controller functions such as main memory control functions typically reside in the north bridge 140. In addition, the north bridge 140 provides bus control to handle transfers between the host bus 120 and a second bus(es), e.g., PCI bus 170 and AGP bus 171, the AGP bus 171 being coupled to the AGP video 172 and/or the video display 174. The second bus may also comprise other industry standard buses or proprietary buses, e.g., ISA, SCSI, USB buses 168 through a south bridge (bus interface) 162. These secondary buses 168 may have their own interfaces and controllers, e.g., RAID storage system 160 and input/output interface(s) 164. Finally, a BIOS 180 is operative with the information handling system 100, as illustrated in FIG. 1. The information handling system 100 can be combined with other like systems to form larger systems. Moreover, the information handling system 100 can be combined with other elements, such as networking elements, to form even larger and more complex information handling systems.

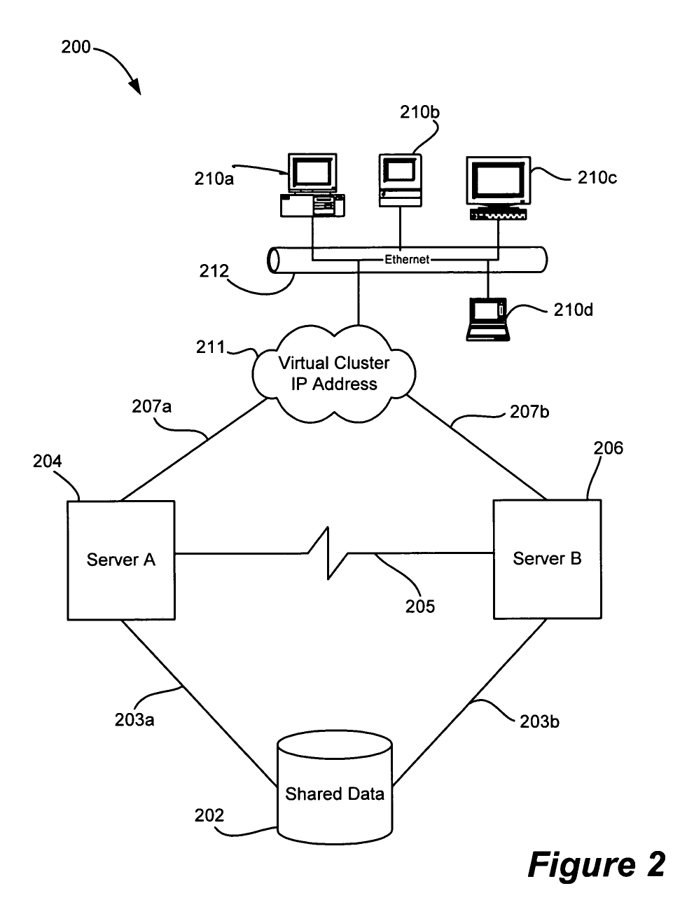

FIG. 2 illustrates a two-node failover cluster. At the base of the cluster 200 is the shared storage unit 202. The shared storage unit can be a storage area network (“SAN”) or other device that can store information emanating from the server A (node) 204 and server B (node) 206. The servers 204 and 206 are connected to the shared data 202 via storage interconnections 203a and 203b, as illustrated in FIG. 2. The server nodes 204 and 206 are connected to a virtual cluster internet protocol (“IP”) address 211 via, for example, Ethernet interconnections 207a and 207b. Clients 210 that issue requests to and receive responses from the cluster 200 are connected to the virtual cluster IP address 211 by, for example, the local area network 212. Between the servers is the cluster heartbeat signal channel 205. Each of the servers of the cluster has at least one heartbeat line 205 that is monitored by at least one other server.

In one embodiment of the present disclosure, the heartbeat 205 is used to determine, for example, some type of application failure, or some type of failure of the paths emanating from the server in question, such as the path 203 to the shared data 202, or the path 207 to the virtual cluster IP address 211. For example, if the path 207a had failed, the server A 204 would still be operative, but it would not be able to send the results back to the clients 210 because the path to the virtual cluster IP address 211 was blocked. In those cases, the heartbeat from the server A 204 would still be active (as determined by the server B 206 via the heartbeat connection 205) so that the server B 206 could either take over the workload of the server A 204, or server A 204 could merely be commanded to convey the results of its work through server B 206 and its operative connection 207b to the client 210 before timeout of the request. Similarly, if the connection 203a between the server A 204 and the shared data 202 becomes inoperative, server A 204 would not be able to store its results, but could, via the heartbeat connection 205, convey its connection problems to server B 206, which could then service the storage request of server A 204.

In another embodiment of the present disclosure, a copy of the request queue of the various servers of the cluster 200 are stored on the shared data 202. In that case, not only can another server take over for the failed sever in case of interruption of the return path (to the virtual cluster IP address 211) or the storage interconnect (to the shared data 202), but another server could also take over in the event of failure of one of the server nodes.

In operation, each path and element (e.g., a node) within the cluster 200 is designated to be in one of three modes: active (operative and in use); passive (operative but not in use); and failed (inoperative). Failed paths are routed around. Other elements are tasked with the work of a failed element. In other words, when a node within the cluster 200 cannot complete its task (either because the node is inoperative, or its connections to its clients are inoperative) then the outstanding transaction queue of the failed node is transferred to one or more surviving nodes using the cluster heartbeat 205. The heartbeat 205 detects whether the path 203 to the storage system is operative and/or if an application on a server node is responsive, and if not, the outstanding requests for that application, or for the node as a whole, can be transferred to one of the other nodes on the cluster 200.

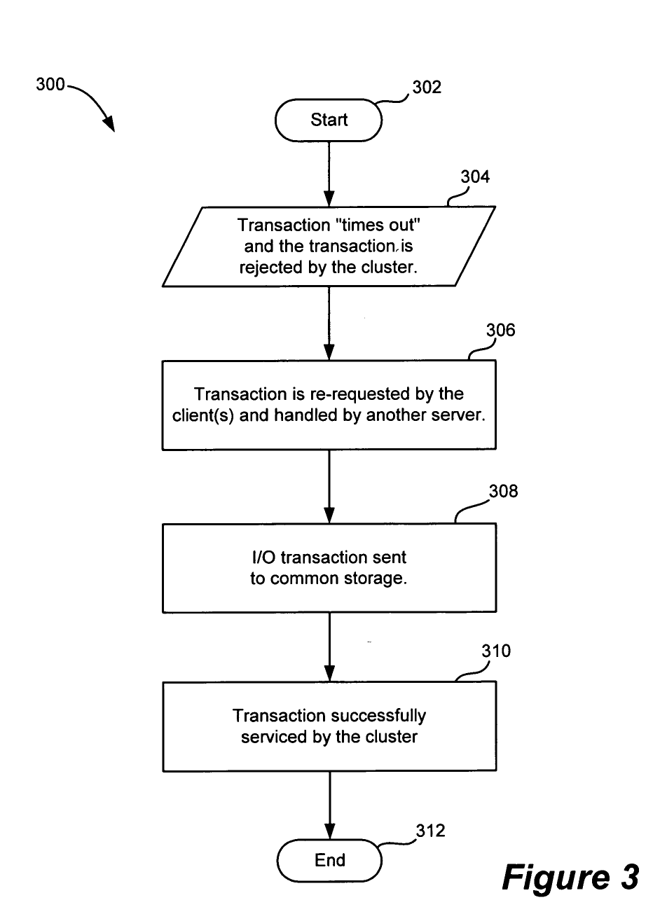

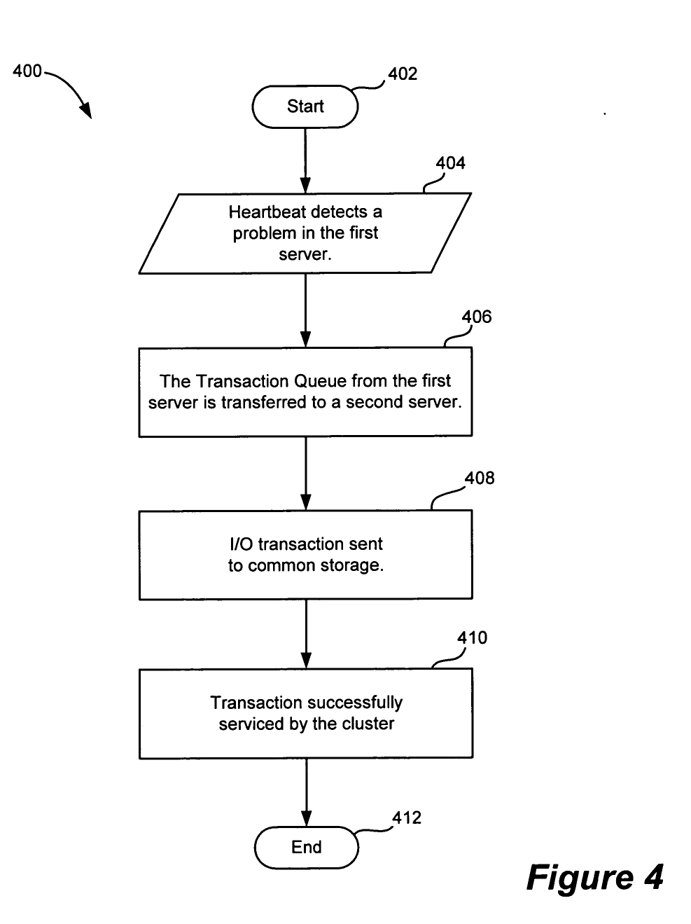

The operation of the present disclosure is better understood with the aid of the flowcharts of FIGS. 3 and 4. It should be noted that the flowcharts of FIGS. 3 and 4 are but illustrative examples of the myriad ways in which the present disclosure can accommodate a failure of one or more elements of the cluster 200. The example of FIG. 3 does not have the benefit of the present disclosure. Instead, the example of FIG. 3 illustrates what happens when the present disclosure is not implemented. In this example scenario 300, the path 203a is inoperative, precluding access to the shared data 202 from server A 204. In that scenario, the server A 204 could not service its request, and the requests tasked to server A 204 would eventually time out (expire). Thus, in step 304, the time out of the transaction would be detected and the transaction rejected by the cluster. In step 306, the transactions that were tasked to server A 204 are re-requested by the one or more clients that initiated the first set of requests. However, unlike the first set of requests, the second set of requests is serviced by a second server B 206. In step 308, the input/output (“I/O”) transaction is received/sent to the common storage (shared data) 202. Finally, the second server B 206 successfully services the requests in step 310, and the example method ends generally at step 312.

The example of FIG. 4 illustrates a different result to the same scenario of FIG. 3 when the present disclosure is implemented. The method 400 begins generally at step 402. As before, the path 203a to the shared data 202 is inoperative, preventing access to the shared data 202 by the first server A 204. As the first server A 204 cannot access the shared data 202, it cannot service its requests. It will be understood that other failures, such as an application on the first server A 204, or failure of the server A 204 itself can cause similar problems. In any case, the heartbeat mechanism 205 will detect the problem with the first server 204 in step 404 of FIG. 4. Once the problem has been detected, the transaction queue of the first server A 204 is transferred to a second server B 206 within the cluster 200 in step 406. In step 408, the I/O transaction is sent to the common (shared data) storage 202. With access to the shared data storage 202, the second server B 206 can service the transaction queue of the first server A 204 successfully in step 410 and the method ends generally at step 412. It will be understood that the ability to detect problems in one server, and then to transfer transaction queues of the affected server to one or more other servers within the cluster, can overcome a myriad number of failures and other problems besides the ones described herein.

In another embodiment of the present disclosure, the transaction queues of the various servers 204, 206, etc., are copied to the shared data storage 202. While such duplexing of the transaction queues marginally increases network traffic, it can prove useful if one of the servers 204, 206 fails completely. In the scenarios described above, although a process on the server, or a portion of the cluster infrastructure servicing the server, were unstable or inoperative, the server itself was still functional. Because the server itself was still functional, it was able to transfer its transaction queue to another server via, for example, the heartbeat connection 205. In this example, however, the server itself is inoperative, and is unable to transfer its transaction queue to another server. To recover from such a failure, a copy of each server's transaction queue is (routinely) stored on the shared data storage 202. In case the first server A 204 fails completely (i.e., in a way that it is unable to transfer the transaction queue to another server) as detected by another sever via the heartbeat mechanism 205, the copy of the transaction queue that resides on the shared data storage 202 is then transferred to the second server B 206 to service the transactions, preferably before the time out on the requesting client device. As with the other examples noted above, the device that determines whether or not a server can perform a transaction (or trigger a failover event) can be another server, or a specialized device, or a cluster management service that is running on another server or node within the cluster. In the examples above, another server within the cluster detects (through the heartbeat mechanism 205) that a problem with one server exists, and that server attempts to handle the failed server's transactions. The second server can receive the failed server's transaction queue via the heartbeat mechanism 205, or through another route on the network within the cluster 200, or by obtaining a copy of the transaction queue from the shared data source 202.

The invention, therefore, is well adapted to carry out the objects and to attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alteration, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

1. A method for failover in a cluster having two or more servers, the two or more servers operative with each other by a heartbeat mechanism, comprising:
detecting a failure of a first server of the two or more servers;
transferring a transaction queue from the first server to a second server of the two or more servers; and
servicing the transactions of the transaction queue of the first server by the second server.

2. The method of claim 1, wherein detecting comprises detecting a failure via the heartbeat mechanism.

3. The method of claim 2, wherein the failure is an unstable application.

4. The method of claim 2, wherein the failure is a data path.

5. The method of claim 1, wherein transferring comprises:
forwarding the transaction queue from the first server to the second server via the heartbeat mechanism.

6. The method of claim 1, wherein transferring comprises:
forwarding the transaction queue from the first server to the second server via a network of the cluster.

7. A method for failover of a sever in a cluster having two or more servers, the two or more servers operative with each other by a heartbeat mechanism, comprising:
copying a transaction queue from a first of the two or more servers to a shared storage device;
detecting a failure of the first server;
transferring the transaction queue from the shared storage device to a second server of the two or more servers; and
servicing the transactions of the transaction queue of the first server by the second server.

8. The method of claim 7, wherein detecting comprises detecting a failure via the heartbeat mechanism.

9. The method of claim 8, wherein the failure is an unstable application.

10. The method of claim 8, wherein the failure is a data path.

11. The method of claim 7, wherein transferring comprises:
forwarding the transaction queue from the shared data source to the second server via a network of the cluster.
